(19) United States
(12) Patent Application Publication
(10) Pub. No.: US 2020/0001338 A1
(43) Pub. Date: Jan. 2, 2020

(54) ASSEMBLY AND WELDING UNIT FOR LONGITUDINALLY WELDED PIPES

(71) Applicant: AKTSIONERNOE OBSHCHESTVO "CHELYABINSKIY TRUBOPROKATNYI ZAVOD" (PAO "CHTPZ"), Chelyabinsk (RU)

(72) Inventors: Aleksandr Igorevich ROMANTSOV, Chelyabinsk (RU); Mikhail Aleksandrovich FEDOROV, Chelyabinsk (RU); Anton Aleksandrovich CHERNYAEV, Trekhgornyi (RU); Aleksandr Olegovich KOTLOV, Emanzhelinsk (RU)

(21) Appl. No.: 16/481,060

(22) PCT Filed: Dec. 5, 2017
(86) PCT No.: PCT/RU2017/000896

§ 371 Date: Jul. 25, 2019

(30) Foreign Application Priority Data
Jan. 30, 2017 (RU) 2017103059

(51) Int. Cl. B21C 37/08; B23K 26/262; B23K 37/02; B23K 37/053

(52) U.S. Cl. CPC B21C 37/08; B23K 26/262; B23K 37/053; B23K 37/0258; B23K 37/0276; B23K 37/0217

(57) ABSTRACT

A longitudinal welded pipe assembly and welding mill contains a trestle, on which a welding bridge configured to move is mounted, such bridge carrying welding equipment with the first welding head designed for welding on the outside of the pipe blank. A pipe blank rotation system and assembly mandrels, each containing a blank pipe longitudinal edge clamping mechanism, are installed in the trestle leg span. The mill is fitted with a cantilever crossbar mounted in the supporting assembly, with the second welding head designed for inside welding, the clamping mechanism made as hydraulic stops. The pipe blank rotation system is a welding trolley configured to move over guides and having rotary rollers designed for positioning a pipe blank in the welding position, and supporting rotary rollers located near the assembly mandrels and configured to diverge crosswise with respect to the guides to enable movement of the welding trolley into the assembly mandrel area and move in reverse up to the stop to the pipe blank surface. Technical result: expansion of the technological capabilities of existing mills by integrating equipment enabling to weld from inside and outside of the pipe blank in various sequence using various technologies and observing the geometrical accuracy of bringing together the blank edges for pipes of various diameter, in particular, for large diameter pipes.

The invention is related to pipe welding, in particular, to assembly and welding mills for large diameter longitudinal pipes.

This area of engineering has a problem optimizing the longitudinal pipe production in terms of integration of process equipment capable of outside and inside welding on pipe blanks.

Prior art pipe welding mills do not solve this engineering problem. The data on such equipment are provided, for example, in descriptions for titles of protection: SU No. 1384353, U.S. Pat. No. 3,377,013, RU No. 129853, RU No. 2359799.

The mill (SU No. 1384353) contains an assembly/welding cage constituting yokes with rolls housed in cassettes, such rolls forming a roll-pass and configured to move in the radial direction. Each of the yokes consists of two pivotally interconnected semiyokes; the cassettes with housed rollers are pivotally mounted in the semiyokes. The yokes have a common rotation axis in the roll-pass symmetry plane, and the yokes located on each side of this plane are combined with longitudinal beams fitted out with a drive of synchronous movement with respect to one another. The assembly/welding cage is installed in the welding area, the assembly is carried out by compressing the pipe blank and welding of its longitudinal edges being connected in the welding area.

Prior art equipment has limited technological capabilities as the mill is designed for welding outside the pipe blank of a certain diameter. Consequently, upon changing the pipe diameter, a separate cage is required.

If welds need to be applied from inside the pipe blank, for example, a root weld or facing weld in manufacturing large diameter pipes, the pipe blank will be moved to the next process sections.

Such a cage may be used only for pipes of a certain diameter; for this reason, manufacture of pipes of any other diameter requires a separate cage, which requires large areas for stockpiling and storage of the whole range of sizes of cages.

Moreover, a cage is not capable of shaping a certain ovality of the profile, which can lead to a larger ovality of the profile at the subsequent production sections.

The mill (U.S. Pat. No. 3,377,013) is designed for assembly of a pipe blank in the six-hour position of the edge butt joint. The mill equipment is made as hydraulic collets providing hold-down of the edges against the cantilever stop surface. In doing so, the weld is applied onto a fixed pipe blank from inside when the welding head is moving along the crossbar installed on the base.

The prior art mill reveals the same engineering problem as the equivalent (U.S. Pat. No. 1,384,353). In other words, if welds need to be applied from inside the pipe blank, for example, root weld or facing weld in manufacturing large diameter pipes, the pipe blank will be moved to the next process sections.

In addition, the welding head moves along the crossbar, which significantly limits the pipe blank welding diameters considering the dimensions of cables, drives, butt-joint tracking system, and the crossbar itself.

Such a mill design is not capable of ensuring a quality hold-down of the thick-walled small-diameter pipe blank walls due to a high rigidity of the pipe blank formed.

The mill (RU No. 129853) contains an assembly/welding straight-through cage with radially-installed beams for pipe blank compression, a roller table to move the pipe blank, and a welding unit with the welding head designed for outside welding.

Considering the purpose of equipment—the welding outside the pipe blank—inside welding is possible in the subsequent production sections.

As the nearest equivalent, the engineering solution (RU No. 2359799) has been selected, which includes a trestle with guides, on which a movable welding bridge is installed carrying welding equipment with a welding head for welding outside the pipe blank. The trestle pillar span contains a pipe blank lifting/rotating mechanism and assembly mandrels with a mechanism for clamping of the pipe blank longitudinal edges.

The use of this mill does not solve the engineering problem as its structural features are limiting the possibility of welding from inside the pipe blank. The structural features of the prior art mill include the availability of several mechanisms ensuring the specified ovality of the pipe blank cross-section.

The proposed invention is aimed at expanding the technological capabilities of existing mills by integrating equipment enabling to weld from inside and outside of the pipe blank in various sequence using various technologies and observing the geometrical accuracy of bringing together the blank edges for pipes of various diameter, in particular, for large diameter pipes.

The existing engineering problem can be solved using a longitudinal pipe assembly and welding mill containing a trestle with guides, on which a welding bridge configured to move is mounted, such bridge carrying welding equipment with the first welding head designed for welding on the outside of the pipe blank; a pipe blank rotation system and assembly mandrels, each containing a blank pipe longitudinal edge clamping mechanism, are installed in the trestle leg span. This mill is fitted out with a cantilever crossbar mounted in the supporting assembly, with the second welding head designed for inside welding, the clamping mechanism is made as hydraulic stops; the pipe blank rotation system is a welding trolley configured to move over guides and having rotary rollers, and supporting rotary rollers located near the assembly mandrels and configured to diverge crosswise with respect to the guides to enable movement of the welding trolley into the assembly mandrel area and to move in reverse up to the stop to the pipe blank surface; the rotary rollers are designed for positioning a pipe blank in the welding position.

The mill declared herein has the following design features.

The mill contains a control system, including a control unit designed for input of signals and output of control signals to the correctors of the first and second welding heads enabling to guide the corresponding welding head to the butt-joint of the pipe blank edges; in addition, a means of displaying data on the position of the first and second welding heads and two triangulation sensors—connected to the control unit inputs—directing at the butt-joint of the pipe blank edges, each of which is installed on the first and second welding heads, respectively.

The mill contains a control system, including a control unit, triangulation sensors of the first and second groups installed on the assembly mandrels, a data display; the control unit is designed for input of signals and output of control signals to hydraulic stops of the assembly mandrels, the sensors of the two groups are connected to the corresponding control unit inputs, the first group sensors are designed for detecting the pipe blank profile in the cross-section located in the area between the assembly mandrels, the second group sensors are designed for detecting the profile of the butt-joint of the pipe blank edges, and the display is designed to display data on the pipe blank cross-section in the area of each assembly mandrel and in the area of the pipe blank edges butt-joint.

The first or the second welding head is a laser welding head for using laser welding technologies, the mill is fitted out with a protection shelter.

The essence of the invention is explained as follows.

The introduction of the pipe blank rotation system, which includes a welding trolley with rotary rollers, into the system enables to rotate the pipe blank to the 12-hour and 6-hour positions for welding.

Because of such structural feature, the proposed mill is fitted out with a cantilever crossbar with a welding head ensuring the application of inside welds in the lower position.

The expansion of the mill's technological capabilities (application of welds from inside and outside the pipe blank) would be problematic without geometrically accurate convergence of the pipe blank edges while observing the specified cross-section shape. For this reason, location of rotary rollers near the assembly mandrels, which enables stopping against the pipe blank surface, enables uniform compression of each area, which includes the pipe blank cross-section in the area of the corresponding assembly mandrel. Consequently, the supporting-rotary rollers being additional supports of the pipe blank (with respect to the welding trolley supports) perform the function of a means enabling uniform compression of the pipe blank over the whole length.

Hence, the integration of equipment for applying various pipe welding technologies enables to bring the pipe blank edges together accurately into a butt-joint.

The accuracy of the pipe blank assembly is controlled using the control system containing sensors connected to the control unit, which is electrically connected, for example, with monitors displaying data on the status of proper pipe blank geometry and proper assembly of the pipe blank edges butt-joint.

The use of a laser or hybrid laser-arc welding head as the first (outside) welding head requires personnel protection against reflected radiation of the fourth hazard level. To this effect, the mill is placed in the shelter having a gate and a roof. Through the gate, the pipe blank is fed into the working zone of the mill and is released from it. The roof can be configured to load welding consumables to the welding bridge and inside the shelter.

To explain the construction of the longitudinal pipe assembly and welding mill, an example of its embodiment with a reference to drawings is provided.

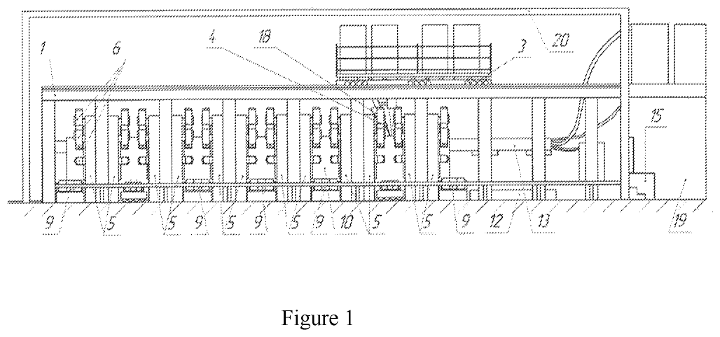

FIG. 1 shows a general view of the mill;

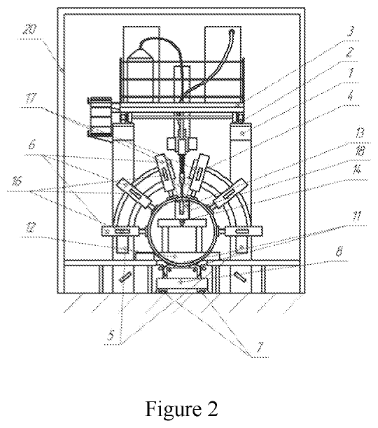

FIG. 2 shows its transverse section.

The large diameter longitudinal pipe assembly and welding mill contains trestle 1 with rail guides 2, on which movable welding bridge 3 is installed; the bridge carries welding equipment with first welding head 4.

Depending on the welding technology, the first head has various designs and can perform welding in the protective gas atmosphere, multiarc welding under a flux layer, laser, and hybrid laser arc welding. To apply several outside welds, the welding bridge is repeatedly passed along the pipe to apply weld under another technology, or the welds are concurrently applied by combining heads for various welding processes into one welding process.

In the span of trestle 1, assembly mandrels 5 are installed with radially located hydraulic stops 6 for pipe blank compression; in addition, rail track 7 is installed with welding trolley 8 configured to move along this rail track, as well as supporting rotary rollers 9 on a hydraulic drive, which are able to diverge crosswise (with respect to the longitudinal axis of the mill) and move in reverse up to the stop against the pipe blank 10 surface.

Supporting-rotary rollers 9 are installed near assembly mandrels 5.

To enable pipe blank 10 to rotate into the welding position (12-hour and 6-hour positions), welding trolley 8 is fitted out with rotary rollers 11.

For weld application inside the pipe blank, the mill is fitted out with cantilever crossbar 13 mounted on supporting assembly 12, with second welding head 14.

The mill is fitted out with a control system including control unit 15 and a system of triangulation sensors 16, 17 installed on assembly mandrels 5 and sensors 18 to guide the pipe blank edge butt-joint installed on welding heads 4 and 14 respectively. First-group sensors 16 detect the profile of pipe blank 10 in the transverse section located in the area between assembly mandrels 5; second-group sensors 17 detect the profile of pipe blank 10 edge butt-joint. Control unit 15 located inside the control station in operator's cab 19 is connected to the monitors (not shown) located at the control station displaying data on measurement of the pipe blank profile, on the profile of the assembled edge butt-joint, on the parameters of pipe blank compression with mandrel stops, on the welding process modes, and on the status of equipment contained in the mill.

The control system integration into structural equipment of the mill enables to shape the specified ovality of the pipe blank profile during accurate bringing of the pipe blank edges together.

The drawings show protective shelter 20, which can be made as a framework with three-layer sandwich panel walls; the inside surface of the shelter is coated with matte paint to enhance the reflected laser radiation scattering.

The claimed mill operates as follows.

A formed pipe blank is transferred to the welding trolley beyond the working area. By means of hydraulic drive, supporting-rotary rollers 9 diverge into opposite sides to enable welding trolley 8 to move along rail track 7 to the mill zone. Cantilever crossbar 13 with second welding head 14 is placed inside pipe blank 10. Pipe blank 10 is oriented by rotary rollers 11 of welding trolley 8 into 12-hour welding position.

Assembly mandrels 5 compress pipe blank 10 with hydraulic stops 6 to bring the pipe blank edges together.

During compression of pipe blank 10, information from sensors 16, 17, 18 displayed on the monitor is analyzed by the operator who, if necessary, adjusts the pipe blank compression by controlling impact of individual stops on the pipe blank.

Upon completion of the pipe blank assembly, the operator moves welding bridge 3 into the initial welding position. Welding head 4 is guided to the edge butt-joint by its own triangulation sensor 18. The welding process on outside of pipe blank 10 is activated.

Upon assembly of the pipe blank with the weld on outside, hydraulic stops 6 of assembly mandrels 5 diverge, and supporting-rotary rollers 9 move away from pipe blank 10.

By means of rotary rollers 11 of welding trolley 8, pipe blank 10 is oriented into 6-hour welding position. Second welding head 14 on cantilever crossbar 13 is lowered to the inside surface of the pipe. Second welding head 14 is guided to the edge butt-joint by its own triangulation sensor 19. The welding process is activated, and welding trolley 8 begins moving at the welding speed toward withdrawal from cantilever crossbar 13, goes out of the work area of the assembly-welding mill and is transferred to other production sections.

The proposed longitudinal pipe welding and assembly mill enables to manufacture customized high-quality long length large diameter tubes using various welding technologies. The work area of the large diameter assembly and welding mill is convenient for placing various welding technology units: gas metal arc welding, gas tungsten arc welding, submerged multiarc welding, laser, and prospective hybrid laser arc welding.

1. A longitudinal pipe assembly and welding mill containing a trestle with guides, on which a welding bridge configured to move is mounted, such bridge carrying welding equipment with the first welding head designed for welding on the outside of the pipe blank; a pipe blank rotation system and assembly mandrels are installed in the trestle leg span, each containing a blank pipe longitudinal edge clamping mechanism, wherein this mill is fitted out with a cantilever crossbar mounted in the supporting assembly, with the second welding head designed for inside welding, the clamping mechanism is made as hydraulic stops; the pipe blank rotation system is a welding trolley configured to move over guides and having rotary rollers, and supporting rotary rollers located near the assembly mandrels and configured to diverge crosswise with respect to the guides to enable movement of the welding trolley into the assembly mandrel area and to move in reverse up to the stop to the pipe blank surface; the rotary rollers are designed for positioning a pipe blank in the welding position.

2. The mill of claim 1, wherein it contains a control system, including a control unit designed for input of signals and output of control signals to the correctors of the first and second welding heads enabling to guide the corresponding welding head to the butt-joint of the pipe blank edges; in addition, a means of displaying data on the position of the first and second welding heads and two triangulation sensors—connected to the control unit inputs—directing at the butt-joint of the pipe blank edges, each of which is installed on the first and second welding heads, respectively.

3. The mill of claim 1, wherein it contains a control system, including a control unit, triangulation sensors of the first and second groups installed on the assembly mandrels, a data display; the control unit is designed for input of signals and output of control signals to hydraulic stops of the assembly mandrels, the sensors of the two groups are connected to the corresponding control unit inputs, the first group sensors are designed for detecting the pipe blank profile in the cross-section located in the area between the assembly mandrels, the second group sensors are designed for detecting the profile of the butt-joint of the pipe blank edges, and the display is designed to display data on the pipe blank cross-section in the area of each assembly mandrel and in the area of the pipe blank edges butt-joint.

4. The mill of claim 1, wherein the first or the second welding head is a laser welding head for using laser welding technologies, the mill is fitted out with a protection shelter.
